(19) United States
(12) Patent Application Publication
(10) Pub. No.: US 2022/0059028 A1
(43) Pub. Date: Feb. 24, 2022

(54) CONTROL APPARATUS, DISPLAY APPARATUS INCLUDING SELF-LUMINOUS ELEMENT, AND CONTROL METHOD

(71) Applicant: SHARP KABUSHIKI KAISHA, Sakai City (JP)

(72) Inventors: MASAFUMI ITO, Sakai City (JP); KENJI MAEDA, Sakai City (JP); TAKUYA OKAMOTO, Sakai City (JP); SHINJI YAMAMOTO, Sakai City (JP); FUMITAKA SEKI, Sakai City (JP); YUICHI SATO, Sakai City (JP); YOHICHI TAKAZANE, Sakai City (JP)

(21) Appl. No.: 17/395,926

(22) Filed: Aug. 6, 2021

(30) Foreign Application Priority Data
Aug. 20, 2020 (JP) 2020-139706

(51) Int. Cl. G09G 3/3225

(52) U.S. Cl. CPC G09G 3/3225; G09G 2360/16; G09G 2320/0626; G09G 2320/064; G09G 2320/0247; G09G 2330/021; G09G 2320/0271; G09G 2310/065

(57) ABSTRACT

A control apparatus configured to control a display apparatus including a self-luminous element includes: an image judgment unit configured to determine whether or not a ratio of a number of pixels located in a predetermined area of an image and having gradation levels within a gradation range from a first gradation level not equal to a lowest gradation level to a second gradation level not equal to a highest gradation level is equal to or larger than a threshold value; and a drive change unit configured to determine a refresh rate of the display apparatus including the self-luminous element according to a result of the determination made by the image judgment unit. The image judgment unit is configured to determine at least one of (1) the value of the first gradation level and the value of the second gradation level, and (2) the threshold value.

### CROSS-REFERENCE TO RELATED APPLICATION

The present application claims priority from Japanese Patent Application No. 2020-139706, the content to which is hereby incorporated by reference into this application.

### BACKGROUND OF THE INVENTION

### 1. Field of the Invention

An aspect of the present disclosure relates to a control apparatus for controlling a display apparatus including a self-luminous element, a control method, and a display apparatus including a self-luminous element.

### 2. Description of the Related Art

EL (electro-luminescence) display apparatuses including EL elements formed using an organic or inorganic material are attracting attention because of their superiority in image quality and the like compared to conventional liquid crystal display apparatuses and the like. It is becoming more popular that such an EL display apparatus is installed on a mobile terminal such as a mobile phone, a smartphone, and a tablet terminal, as well as a television receiver, a notebook PC (personal computer), and the like. In such EL display apparatuses, it is desirable to reduce power consumption.

An example of a method of reducing the power consumption of a display apparatus is to reduce a refresh rate of the display apparatus. In recent years, intensive efforts have been made to develop a display apparatus including a thin film transistor (TFT) realized by an oxide semiconductor using indium (In), gallium (Ga), and zinc (Zn). By forming TFTs using an oxide semiconductor, it is possible to achieve a small leakage in an off state. Therefore, in display apparatuses using oxide semiconductors, it is possible to reduce the refresh rate to a low value such as about 1 Hz.

However, when a display apparatus is driven at a low refresh rate, there may occur a problem that an easily-visible flicker occurs. To handle such a situation, Pamphlet of International Publication No. WO2014/080731 discloses a technique for changing the refresh rate of a liquid crystal display apparatus depending on a gradation level of a pixel of an image displayed on the liquid crystal display apparatus such that flicker is not easily perceivable.

However, it is difficult to apply the technique disclosed in Pamphlet of International Publication No. WO2014/080731 to EL display apparatuses. This is because the visibility of the flicker on the display apparatus depends on the magnitude of a gamma voltage.

In the case of a liquid crystal display apparatus, the luminance of a screen can be adjusted by controlling the amount of light from a rear backlight. Therefore, in the liquid crystal display apparatus, the gamma voltage can be maintained at a desirable value regardless of the luminance of the screen. On the other hand, in the EL display apparatus having no rear backlight, the luminance of the screen and the gamma voltage correlate with each other. In the technique disclosed in Pamphlet of International Publication WO2014/080731, the gamma voltage is not taken into account, and thus when this technique is directly applied to the EL display apparatus, it is difficult to properly control the refresh rate.

Thus, in a display apparatus including a self-luminous element, it is desirable to control the refresh rate so as to achieve both a reduction in power consumption and a reduction in visibility of flicker.

### SUMMARY OF THE INVENTION

According to an aspect of the disclosure, there is provided a control apparatus configured to control a display apparatus including a self-luminous element, including an image judgment unit configured to determine whether or not a ratio of a number of pixels located in a predetermined area of an image and having gradation levels within a gradation range from a first gradation level not equal to a lowest gradation level to a second gradation level not equal to a highest gradation level is equal to or larger than a threshold value, and a drive change unit configured to determine a refresh rate of the display apparatus including the self-luminous element according to a result of the determination made by the image judgment unit, the image judgment unit being configured to determine at least one of (1) the value of the first gradation level and the value of the second gradation level, and (2) the threshold value.

According to an aspect of the disclosure, there is provided a method of controlling a display apparatus including a self-luminous element, the method including acquiring a set value for luminance of the display apparatus including the self-luminous element, determining whether or not a ratio of a number of pixels located in a predetermined area of an image and having gradation levels within a gradation range from a first gradation level not equal to a lowest gradation level to a second gradation level not equal to a highest gradation level is equal to or larger than a threshold value, and changing a refresh rate of the display apparatus including the self-luminous element according to a result of the determining, the determining including setting at least one of (1) the value of the first gradation level and the value of the second gradation level, and (2) the threshold value, according to the set value for the luminance.

### BRIEF DESCRIPTION OF THE DRAWINGS

FIG. 1 is a block diagram illustrating a configuration of a display apparatus according to a first embodiment;

FIG. 2A is a diagram illustrating a relationship between a gamma voltage and a gradation level of a display apparatus for a case where the luminance is set to be high according to the first embodiment;

FIG. 2B is a diagram illustrating a relationship between a gamma voltage and a gradation level of a display apparatus for a case where the luminance is set to be low according to the first embodiment;

FIG. 3 is a diagram illustrating a timing chart related to an operation of displaying an image by a display apparatus according to the first embodiment;

FIG. 4 is a flowchart illustrating an example of a control method executed by a host control apparatus according to the first embodiment;

FIG. 5 is a flowchart illustrating another example of a control method executed by the host control apparatus according to the first embodiment;

FIG. 6 is a diagram illustrating an example of a screen of a display apparatus according to the first embodiment; and

FIG. 7 is a block diagram illustrating a configuration of a display apparatus according to a second embodiment.

### DETAILED DESCRIPTION OF THE INVENTION

### First Embodiment

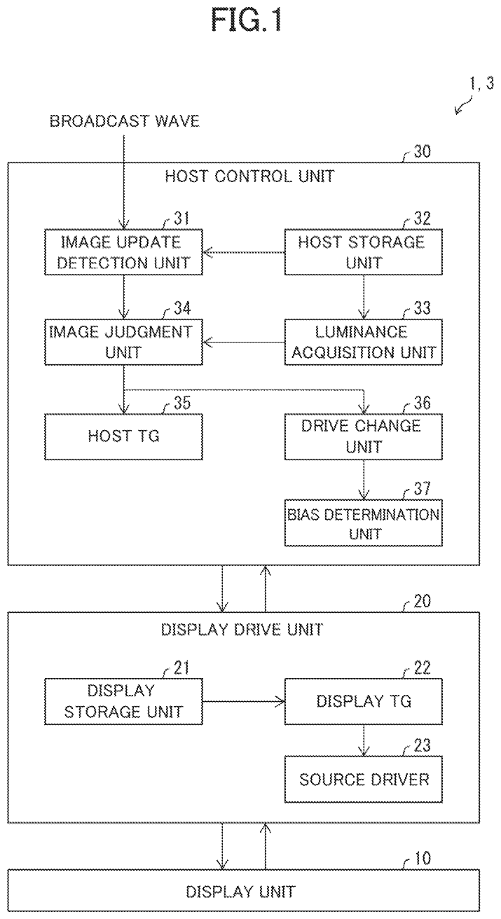

An embodiment of the present disclosure is described below with reference to FIGS. 1 to 6.

### Configuration of Display Apparatus 1

FIG. 1 is a block diagram illustrating a configuration of a display apparatus (a display apparatus including a self-luminous element) 1 according to a first embodiment of the present disclosure. The display apparatus 1 includes a display unit 10, a display drive unit 20 and a host control unit (a control apparatus) 30.

### Display Unit 10

The display unit 10 is a component that displays an image. The image displayed by the display unit 10 may include a still image and a moving image. The display element (the self-luminous element) included in the display unit 10 is an organic EL element which is an electroluminescent element formed using an organic material. Unlike the liquid crystal element, the organic EL element is not subjected to AC-driving, and thus a polarity reversal does not occur for a certain period of time. Therefore, in the organic EL element, a characteristic shift such as a screen burn-in is not likely to occur. This makes it possible to reduce the refresh rate of the image displayed on the display unit 10 to a low value, for example, 0.0056 Hz (once about every 3 minutes). The reduction in the refresh rate results in a reduction in consumption power. The display element of the display unit 10 may be an inorganic EL element which is an electro-luminescence element formed using an inorganic material. Note that the refresh rate refers to a frequency of updating displaying of the display unit 10 regardless of whether or not a change occurs in the content of the image displayed on the display unit 10. That is, the display apparatus 1 may drive the display unit 10 without rewriting the data once or more during a pause frame.

The display unit 10 is, for example, an oxide semiconductor display panel functioning as an active-matrix display panel. The oxide semiconductor display panel is a display panel in which oxide semiconductor TFTs are used as switching elements provided such that one switching element corresponds to every one or more pixels arranged in a two-dimensional manner. The oxide semiconductor TFT is a TFT in which an oxide semiconductor is used as a semiconductor layer. An example of an oxide semiconductor is one using oxides of In, Ga, and Zn (an InGaZnO-based oxide semiconductor).

Oxide semiconductor TFTs have a feature that a large current in an on state and a low leakage current in an off state are achieved. In addition, oxide semiconductor TFTs have good switch-off characteristics, that is, a small amount of charge leakage is achieved in a state in which the switch is turned off, and an excellent charge retention characteristic is obtained. Therefore, by using oxide semiconductor TFTs as switching elements, it is possible to effectively reduce the refresh rate of the image displayed on the display unit 10.

### Host Control Unit 30

The host control unit 30 includes a screen update detection unit 31, a host storage unit (a storage unit) 32, a luminance acquisition unit 33, an image judgment unit 34, a host TG (Timing Generator) 35, and a drive change unit 36. The host control unit 30 includes a control circuit, for example, formed on a substrate. More specifically, for example, the host control unit 30 may be a CPU (Central Processing Unit), a GPU (Graphics Processing Unit), or an apparatus including a CPU, GPU, or the like.

The screen update detection unit 31 detects whether to update the image displayed on the screen of the display unit 10. In a case where it is detected that the image displayed on the screen of the display unit 10 is to be updated, the screen update detection unit 31 acquires display data including an image to be displayed and outputs the acquired display data to the image judgment unit 34. It is detected that the image displayed on the screen of the display unit 10 is to be updated, for example, when one of situations (1) to (3) described below occurs. (1) When an application stored in the host storage unit 32 is started on the display apparatus 1, and the screen update detection unit 31 is notified of updating of the image displayed on the screen when the application is being executed. (2) When a user of the display apparatus 1 notifies the screen update detection unit 31 of updating of the image displayed on the screen via an input unit (not shown). (3) When the screen update detection unit 31 is notified of updating of the image displayed on the screen by data streaming via the Internet or broadcast waves.

The display data acquired by the screen update detection unit 31 includes an image of a frame to be updated and a display update flag (a time reference) indicating the timing of displaying the image. In a case where no change occurs in the content of the image over a plurality of frames, the display data may not include the image for the frames for which no change occurs in the content of the image. The screen update detection unit 31 can detect, based on the display update flag, whether the display is to be updated.

The screen update detection unit 31 may determine whether the image is a moving image or a still image. For example, the screen update detection unit 31 causes the host storage unit 32 to store a frame time at which a change occurs in the content of the image. Based on the display update flag, the screen update detection unit 31 detects an interval from a frame time at which a change occurs in the image content to a frame time at which a next change occurs in the image content. The screen update detection unit 31 can determine whether the image displayed on the screen is a moving image or a still image based on the interval at which the content of the image changes. The screen update detection unit 31 outputs a result of the determination as to whether the image is a moving image or a still image to the drive change unit 36.

The host storage unit 32 is a storage apparatus that stores setting information related to the display apparatus 1 and information processed by the host control unit 30. The host storage unit 32 may be a VRAM (Video Random Access Memory), a ROM (Read Only Memory), an HDD (Hard Disk Drive), an SSD (Solid State Drive), or the like. The host storage unit 32 is not limited to being disposed in the host control unit 30. For example, instead of being disposed in the host control unit 30, the host storage unit 32 may be located outside the host control unit 30 and may be connected to the host control unit 30. Note that the host storage unit 32 may be connected to the host control unit 30 in either one of two manners, in a first one of which the host storage unit 32 is disposed in the host control unit 30 and is connected to the host control unit 30, while in a second one of which the host storage unit 32 is located outside the host control unit 30 and is connected to the host control unit 30. Also note that the number of host storage units 32 provided in the display apparatus 1 is not limited to one, but the display apparatus 1 may include a plurality of host storage units 32.

The luminance acquisition unit 33 acquires a luminance value (a set value for the luminance) of the display apparatus 1. More specifically, the luminance acquisition unit 33 acquires the luminance value of the screen of the display unit 10. In a case where the set value for the luminance of the screen of the display unit 10 is stored in the host storage unit 32 of the host control unit 30, the luminance acquisition unit 33 may acquire the luminance value of the screen of the display unit 10 from the host storage unit 32.

The luminance acquisition unit 33 may acquire an actual luminance value of the screen of the display unit 10 from the display unit 10. More specifically, the luminance acquisition unit 33 calculates the luminance value of the screen of the display unit 10 from the value (the voltage value) of the gamma voltage applied to the display unit 10 of the display apparatus 1 thereby acquiring the luminance value. The value of the gamma voltage applied to the display unit 10 and the luminance value of the screen of the display unit 10 are correlated to each other, and the correlation is determined by the characteristics of the display unit 10. Therefore, the luminance acquisition unit 33 may calculate the luminance value based on the correlation derived from the characteristics of the display unit 10. By employing the above-described configuration, the luminance acquisition unit 33 can always acquire the accurate luminance value of the display unit 10.

The luminance acquisition unit 33 outputs the acquired luminance value to the image judgment unit 34.

The image judgment unit 34 determines whether or not the image included in the display data is an image which is prone to flicker. Whether or not the image is one which is prone to flicker depends on the gradation level of the image. In general display apparatuses, it is known that flicker is more likely to occur at intermediate gradation levels. Here, the intermediate gradation levels are gradation levels excluding saturation gradation levels (minimum and maximum gradation levels). For example, when the minimum gradation level is 0 and the maximum gradation level is 255, the range of the intermediate gradation levels is from the gradation level 1 to the gradation level 254.

For example, in the case of normally black, among the intermediate gradation levels, visible flicker is likely to occur in a range of gradation levels from 10 to 200. Visible flicker is more likely to occur in a range of gradation levels from 20 to 80, and yet more likely to occur in a range of gradation levels from 40 to 60. For example, when an image including many pixels in the above-described gradation ranges is displayed at a refresh rate of 1 Hz, the screen is updated every second, and thus the user may visually perceive the flicker every second.

Thus, when there are a small number of pixels having gradation levels within the gradation range, the host control unit 30 reduces the refresh rate to reduce the power consumption, while when there are a large number of pixels having gradation levels within the gradation range, the host control unit 30 increases the refresh rate to make it difficult for flicker from being visible.

The image judgment unit 34 determines, for each pixel located in a particular area of the image, whether the gradation level of the pixel is within a range from a gradation range from a first gradation level not equal to the lowest gradation level to a second gradation level not equal to the highest gradation level. Furthermore, the image judgment unit 34 determines the ratio of the number of pixels which are located in a particular area of the image and whose gradation levels are within the above-described gradation range to the total number of pixels located in the particular area. For example, the image judgment unit 34 may generate a histogram in which a plurality of pixels are classified in increments of 10 gradation levels, and may determine, from the histogram, the ratio of the number of pixels whose gradation levels fall within the above-described gradation range. Note that the particular area may be the entire area of the image or a part of the entire area of the image.

The image judgment unit 34 determines whether or not the ratio of the number of pixels with gradation levels within the above-described gradation range is equal to or larger than a predetermined gradation threshold value (a threshold value). When the ratio of the number of pixels with gradation levels within the gradation range is equal to or larger than the gradation threshold value, the image judgment unit 34 determines that the image is an image prone to flicker, while when the ratio is smaller than the gradation threshold value, it is determined that the image is not an image prone to flicker. The image judgment unit 34 outputs display data to the host TG 35, and outputs, to the drive change unit 36, a result of the determination as to whether or not the ratio of the number of pixels with gradation levels within the gradation range is equal to or larger than the gradation threshold value.

In the judgment as to whether the image is an image pone to flicker, the image judgment unit 34 also takes into account the luminance value of the screen of the display unit 10. The visibility of the flicker depends on the magnitude of the gamma voltage applied to the screen of the display unit 10. The larger the gamma voltage applied to the display unit 10, the higher the visibility of the flicker. The display unit 10 operates using EL elements, and thus, unlike the liquid crystal display panel in which the luminance value is adjusted by controlling the backlight voltage, the luminance value is adjusted by controlling the gamma voltage. Therefore, the luminance value of the screen of the display unit 10 correlates with the gamma voltage.

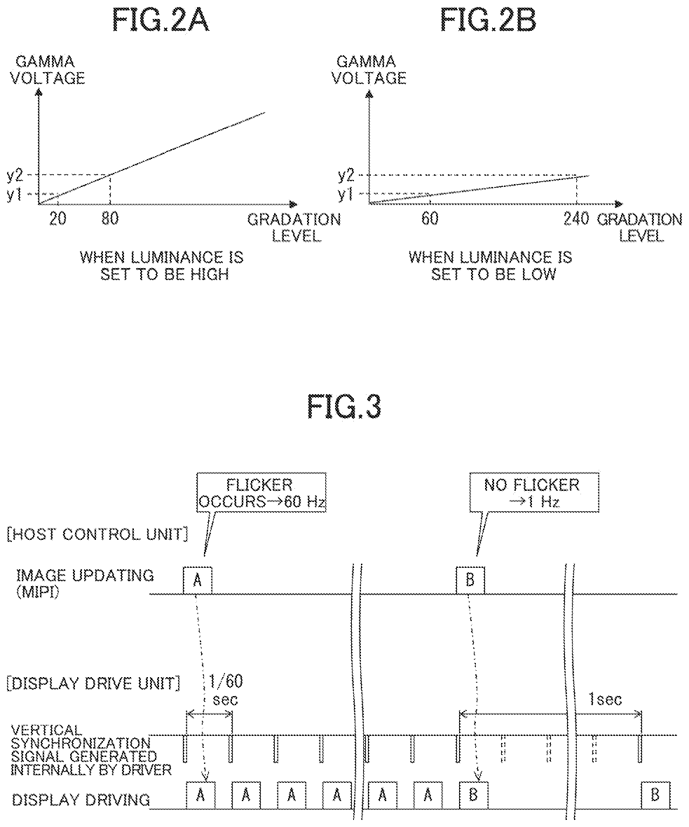

FIG. 2A is a diagram illustrating an example of a relationship between a gamma voltage and a gradation level of a display apparatus for a case where the luminance is set to be high, and FIG. 2B is a diagram illustrating an example of a relationship between a gamma voltage and a gradation level of a display apparatus for a case where the luminance is set to be low. As shown in FIGS. 2A and 2B, when the screen of the display unit 10 is set to be low in luminance, the value of the gamma voltage applied to the display unit 10 is low at each gradation level. For example, in the case where the screen of the display unit 10 is set to be high in luminance, let y1 denote a gamma voltage corresponding to the gradation level 20 and let y2 denote a gamma voltage corresponding to the gradation level 80. When the screen of the display unit 10 is set to be low in luminance, the gradation level 60 corresponds to the voltage y1, and the gradation level 240 corresponds to the voltage y2. That is, in the case where the luminance is set to be low, flicker is prone to occur at more gradation levels in a gradation range different from a gradation range in which flicker is prone to occur when the luminance is set to be high. As described above, the lower the luminance value of the screen of the display unit 10, the higher the visibility of the flicker.

Thus, when the screen of the display unit 10 is set to be low in luminance, the image judgment unit 34 may set the gradation threshold value to a value smaller than in the case where the screen of the display unit 10 is set to be high in luminance. More specifically, when the luminance value of the screen of the display unit 10 is smaller than a predetermined luminance threshold value, the image judgment unit 34 may set the gradation threshold value to a first threshold value, while when the luminance value is larger than the predetermined luminance threshold value, the image judgment unit 34 may set the gradation threshold value to a second threshold value larger than the first threshold value.

In a case where the screen of the display unit 10 is set to be low in luminance, the image judgment unit 34 may set the gradation range to a wider range. More specifically, when the luminance value of the screen of the display unit 10 is smaller than the predetermined luminance threshold value, the image judgment unit 34 may set the first gradation level as the first set value and the second gradation level as the second set value. When the luminance value is equal to or larger than the predetermined luminance threshold value, the image judgment unit 34 may set the first gradation level to a third set value smaller than the first set value, and may set the second gradation level to a fourth set value smaller than the second set value. In this case, the image judgment unit 34 may set the first and second gradation levels such that the range from the first set value to the second set value is wider than the range from the third set value to the fourth set value.

The image judgment unit 34 may set the gradation threshold value according to the luminance value of the screen of the display unit 10 or may set the gradation range as described above, or may set both the gradation threshold value and the gradation range. More specifically, the image judgment unit 34 may set at least one of (1) the value of the first gradation level and the value of the second gradation level, and (2) the gradation threshold value.

Note that in a case where the image judgment unit 34 sets only one of the gradation threshold value and the gradation range according to the above-described luminance value, the other one may be set by employing a value stored in advance in the host storage unit 32. By using the image judgment unit 34 configured in the above-described manner, when the screen of the display unit 10 is set to be low in luminance, even in a case where the ratio of pixels having gradation levels within the gradation range is low, it is possible to correctly determine, taking into account the luminance value, whether or not an image of interest is prone to flicker.

When the host TG 35 acquires display data from the image judgment unit 34, the host TG 35 transfers the display data to the display drive unit 20. Note that the host TG 35 transfers display data of a frame that is to be updated to the display drive unit 20 only when the image displayed on the display unit 10 is to be updated according to the display update flag included in the display data. Transferring of display data may be performed according to data communication specifications for mobile devices such as MIPI (Mobile Industry Processor Interface). Note that the host TG 35 transfers a synchronization signal together with the display data to the display drive unit 20.

The drive change unit 36 determines the refresh rate of the display unit 10 based on the result of the determination made by the image determination unit 34. In a case where the ratio of the number of pixels with gradation levels within the gradation range is smaller than the gradation threshold value, the drive change unit 36 determines that the image is to be refreshed at a first rate, which is a low refresh rate (for example, 1 Hz). In this case, the host control unit 30 can reduce the power consumption of displaying performed by the display apparatus 1.

On the other hand, in a case where the ratio of the number of pixels with gradation levels within the gradation range is equal to or larger than the gradation threshold value, the drive change unit 36 determines that the refresh is to be performed at a second rate (for example, 60 Hz) which is higher than the first rate. Thus, as for images prone to flicker, the host control unit 30 controls the display apparatus 1 to display the image at the high refresh rate thereby effectively making it difficult for the flicker from being perceived by a user.

As described above, the host control unit 30 determines the refresh rate based on both the gradation level of the image and the luminance value of the screen of the display unit 10. Thus, the host control unit 30 can achieve both low power consumption of the display apparatus 1 and a reduction of flicker visibility by appropriately controlling the refresh rate.

The drive change unit 36 may determine the refresh rate described above only when the result of the determination, made by the screen update detection unit 31 as to whether the image of interest is a still image or a moving image, indicates that the image of interest is a still image. In a case where the image of interest is a moving image, the drive change unit 36 may determine that the image is to be displayed while fixing the refresh rate to the second rate described above, or may determine that the image is to be displayed at a refresh rate determined depending on the frame rate of the moving image. The refresh rate determined depending on the frame rate of the moving image may be equal to, for example, a third rate (for example, 30 Hz) which is equal to or higher than the first rate and equal to or lower than the second rate.

Since the display apparatus 1 operates using organic EL elements, the first rate may be set to be lower than 1 Hz. The first rate may be set to, for example, 0.017 Hz (updating is performed approximately once every 1 minute) or 0.0056 Hz (updating is performed approximately once every 3 minutes). The second rate may be set to 60 Hz or higher, for example, 120 Hz.

### Display Drive Unit 20

The display drive unit 20 drives the display unit 10 under the control of the host control unit 30. The display drive unit 20 may be, for example, a so-called COG (Chip on Glass) driver which is COG-mounted on a glass substrate of the display unit 10, or a so-called COF (Chip on Flexible) driver which is COF-mounted on a flexible substrate of the display unit 10. Alternatively, the display drive unit 20 may be a so-called COP (Chip on Plastic) driver which is COP-mounted on a plastic substrate of the display unit 10. The display drive unit 20 includes a display storage unit 21, a display TG (Timing Generator) 22, and a source driver 23.

The display storage unit 21 stores display data transferred from the host control unit 30. The display storage unit 21 keeps the stored display data until next updating of the display is performed (that is, unless the content of the image changes). The display storage unit 21 may be a VRAM or the like as with the host storage unit 32.

The display TG 22 reads the display data from the display storage unit 21 based on the refresh rate determined by the drive change unit 36, and outputs the display data to the source driver 23. Furthermore, the display TG 22 generates a timing signal for driving the display unit 10 at the refresh rate determined by the drive change unit 36, and supplies the timing signal to the source driver 23. In generating the timing signal, the display TG 22 may use a synchronization signal supplied from the host TG 35.

The source driver 23 writes a display voltage corresponding to the display data to a pixel of the display unit 10 according to the timing signal supplied from the display TG 22.

An example of the display apparatus 1 is a display apparatus used in an apparatus supposed to be good in portability such as a mobile phone, a smartphone, a notebook PC, a tablet terminal, an electronic book reader, a PDA or the like. In a case where, like a desktop PC or the like, the EL display apparatus includes the display unit 10 and the display drive unit 20, and the host control unit 30 is provided in an apparatus different from the EL display apparatus (for example, the PC unit), the EL display apparatus falls in the scope of an aspect of the present disclosure.

### Display Drive Method

FIG. 3 is a timing chart of an operation performed by the display apparatus 1 to display a still image. In the example shown in FIG. 3, still images A and B are sequentially displayed on the display unit 10 which is set to be high in luminance. The image A is an image whose ratio of the number of pixels with gradation levels within the gradation range is equal to or larger than the gradation threshold value, and thus the image A is an image prone to flicker even in the high luminance condition. The image B is an image whose ratio of the number of pixels with gradation levels within the gradation range is smaller than the gradation threshold value, and thus the image B is an image which is not prone to flicker in the high luminance condition. Thus, the image A is displayed with a refresh rate of 60 Hz, while the image B is displayed with a refresh rate of 1 Hz.

As shown in the example of FIG. 3, the host control unit 30 transfers display data (of image A or B) of one frame to the display drive unit 20 only when a change occurs in the content of the image. After the display data of the image A is transferred, next transferring of display data from the host control unit 30 to the display drive unit 20 is performed when the displayed image is updated to the image B.

The display drive unit 20 stores the received display data (of the image A) in the display storage unit 21, and updates the image displayed on the display unit 10 to the image A with synchronization with a vertical synchronization signal generated internally in the driver. The vertical synchronization signal generated internally in the driver is generated by the display TG 22 according to the refresh rate determined by the drive change unit 36. Note that a delay time from the reception of the display data to the displaying by the display drive unit 20 is omitted here.

After that, the displaying of the image A is updated every 1/60 seconds. In the display drive unit 20, the display TG 22 reads the display data (of the image A) from the display storage unit 21 every 1/60 seconds, and the source driver 23 supplies the display data to the display unit 10.

On the other hand, after the image B is displayed on the display unit 10, the displayed image B is updated every second. In the display drive unit 20, the display TG 22 reads the display data (of the image B) from the display storage unit 21 every second, and the source driver 23 supplies the display data to the display unit 10.

### Flow of Determining Refresh Rate

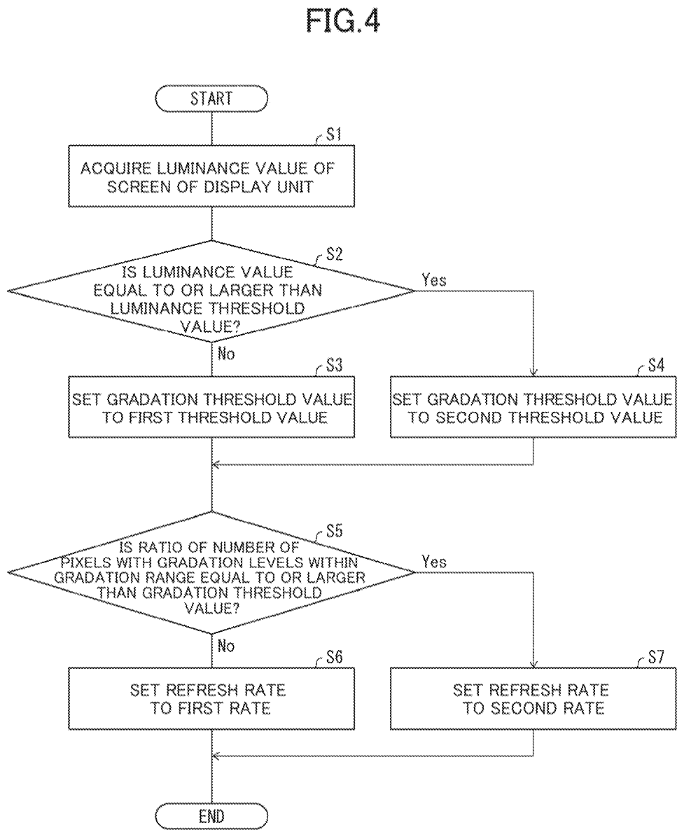

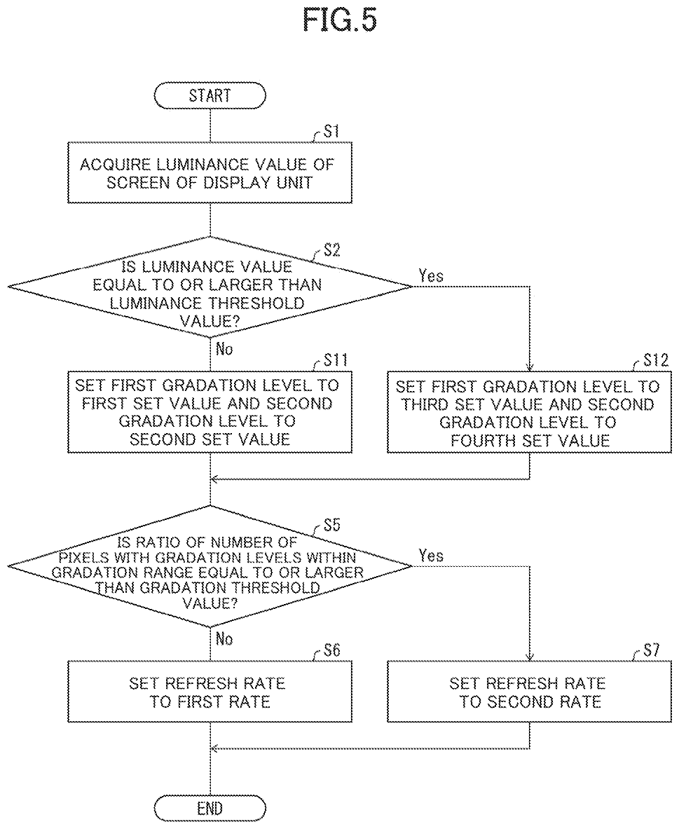

As a method of controlling the display apparatus 1, an example of a method of determining the refresh rate by the host control unit 30 is described below with reference to FIGS. 4 and 5.

As shown in FIG. 4, first, the luminance acquisition unit 33 acquires a luminance value of the screen of the display unit 10 (luminance acquisition step S1). Next, the image judgment unit 34 determines whether or not the luminance value is equal to or larger than a predetermined luminance threshold value (S2). The predetermined luminance threshold value may be a luminance value corresponding to a gamma voltage having a value smaller than the maximum value of the gamma voltage applied to the display unit 10. The predetermined luminance threshold value may be, for example, a luminance value corresponding to a value at which the gamma voltage applied to the display unit 10 is ¾ of the maximum value of the gamma voltage, or may be a luminance value corresponding to a value at which the gamma voltage applied to the display unit 10 is half the maximum value of the gamma voltage.

In a case where the luminance value is smaller than the predetermined luminance threshold value (No in S2), the image judgment unit 34 sets the gradation threshold value to the first threshold value (for example, 15%). In a case where the luminance value is equal to or larger than the predetermined luminance threshold value (Yes in S2), the image judgment unit 34 sets the gradation threshold value to the second threshold value (for example, 30%). As described above, the first threshold value is smaller than the second threshold value. Therefore, in a case where the luminance is set to be low and thus flicker is prone to occur, the image judgment unit 34 sets the gradation threshold value to a stricter value. In other words, in a case where the luminance value is smaller than the luminance threshold value, the image judgment unit 34 determines the gradation threshold value to a value which causes the image to be determined as an image prone to flicker with a larger probability than in a case where the luminance value is equal to or larger than the luminance threshold value.

Next, the image judgment unit 34 evaluates an image included in the acquired display data as to whether or not the ratio of the number of pixels with gradation levels within the gradation range (for example, from the gradation level 20 to the gradation level 80) is equal to or larger than the gradation threshold value set in S3 or S4 (image judgment step S5). In the example shown in FIG. 4, the image judgment unit 34 may use a gradation range which is set in advance. That is, the image judgment unit 34 may use the preset gradation range regardless of the luminance value.

The image judgment unit 34 outputs the determination result obtained in S5 to the drive change unit 36. In a case where the image judgment unit 34 determines that the ratio of the number of pixels within the gradation range is smaller than the gradation threshold value (No in S5), the drive change unit 36 sets the refresh rate to the first rate (for example, 1 Hz) (drive change step S6). In a case where the image judgment unit 34 determines that the ratio of the number of pixels within the gradation range is equal to or larger than the gradation threshold value (Yes in S5), the drive change unit 36 sets the refresh rate to the second rate (for example, 60 Hz) (drive change step S7).

As described above, the drive change unit 36 determines that the image is to be displayed with the low refresh rate only when the image judgment unit 34 determines that the image is not an image prone to flicker. Note that the luminance value of the screen of the display unit 10 and the gradation level of the image are both used in the judgment by the image judgment unit 34. Thus, the host control unit 30 can achieve both low power consumption of the display apparatus 1 and a reduction of flicker visibility by appropriately controlling the refresh rate.

FIG. 5 shows another example, different from that shown in FIG. 4, of a method of determining the refresh rate by the host control unit 30. In the example shown in FIG. 5, processes in S1, S2, S6, and S7 are the same as those shown in FIG. 4, and thus a description thereof is omitted.

As shown in FIG. 5, in a case where the luminance value acquired by the luminance acquisition unit 33 is smaller than the predetermined luminance threshold value (No in S2), the image judgment unit 34 sets the first gradation level to the first set value (for example, the gradation level 60), and the second gradation level to the second set value (for example, the gradation level 240) (S11). In a case where the luminance value is equal to or larger than the predetermined luminance value (Yes in S2), the image judgment unit 34 sets the first gradation level to the third set value (for example, gradation level 20) and sets the second gradation level to the fourth set value (for example, gradation level 80) (S12).

Thereafter, the image judgment unit 34 evaluates the image included in the acquired display data as to whether or not the ratio of the number of pixels within the gradation range set in S11 or S12 is equal to or larger than the gradation threshold value (for example, 30%) (image judgment step S5). In the example shown in FIG. 5, the image judgment unit 34 may employ a preset value as the gradation threshold value. That is, the image judgment unit 34 may use the predetermined gradation threshold value regardless of the luminance value.

In the technique described above, the gradation range used by the image judgment unit 34 for the judgment is wider in the case where the luminance is set to be low than in the case where the luminance is set to be high. Therefore, when the luminance is set to a low value at which flicker is prone to occur, the image judgment unit 34 sets a wider gradation range to the gradation range in which flicker is prone to occur. In other words, the image judgment unit 34 sets the gradation range such that in the case where the luminance value is smaller than the luminance threshold value, the probability that a given image is determined to be an image prone to flicker higher than in the case where the luminance value is equal to or larger than the luminance threshold value.

Note that it is allowed to set a plurality of predetermined luminance threshold values, and gradation threshold values and/or gradation ranges may be set differently for the respective luminance threshold values.

### Modifications

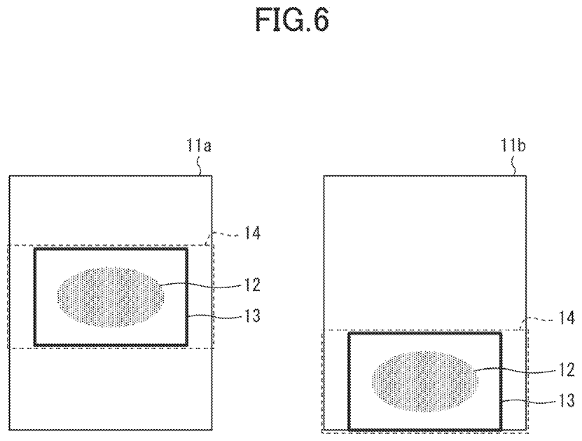

A modification of the control method for the display apparatus 1 according to the present embodiment is described below with reference to FIG. 6. In the display apparatus 1 according to the embodiment described above, the image judgment unit 34 employs the whole image area as the predetermined area, and determines the ratio of the number of pixels with gradation levels within the gradation range in the predetermined area to the total number of pixels located in the predetermined area. However, as with the modification described below, the image judgment unit 34 may employ a part of the image area as the predetermined area, and may determine the ratio of the number of pixels with gradation levels within the gradation range in the predetermined area to the number of pixels located in the predetermined area.

FIG. 6 is a diagram showing a screen of a display unit 10 of a display apparatus 1 according to the present modification. The uniformity of the pixel capacitance over the screen of the display unit 10 may vary depending on the manufacturing process of the display unit 10. Therefore, on the screen of the display unit 10, non-uniformity of the pixel capacitance often occurs only in a particular area. For example, in the case of a screen 11a shown as an example in FIG. 6, a distribution of non-uniform pixel capacitance occurs in a central area 12. In the case of a screen 11b, a distribution of non-uniform pixel capacitance occurs in a bottom area 12. That is, even in a case where a displayed image has gradation levels which are equal over the entire screen, visible flicker is prone to occur in the central area of the image in the example of the screen 11a, while visible flicker is prone to occur in the bottom area of the image in the example of the screen 11b.

Therefore, by determining whether or not pixels having gradation levels that are likely to cause flicker are distributed in the area of the image corresponding to the area 12 in which the pixel capacitance is not uniform, it is possible to determine whether or not the image is an image prone to flicker.

In a case where the display unit 10 of the display apparatus 1 according to the present modification has a characteristic such as that of the screen 11a shown in FIG. 6, the image judgment unit 34 designates a part of the central area of the image as a predetermined analysis area 13. In a case where the display unit 10 of the display apparatus 1 according to the present modification has a characteristic such as that of the screen 11b shown in FIG. 6, the image judgment unit 34 designates a part of the bottom area of the image as the predetermined analysis area 13. The analysis area 13 includes an area corresponding to an area 12 in which the pixel capacitance is not uniform. The image judgment unit 34 determines whether or not the ratio of the number of pixels with gradation levels within the gradation range in the analysis area 13 is equal to or larger than the gradation threshold value.

Note that also in a case where the image judgment unit 34 sets a part of the image area as the predetermined area, the luminance acquisition unit 33 may acquire the overall luminance value for the entire screen of the display unit 10.

As described above, by determining the ratio of the number of pixels with intermediate gradation levels only for a part of the image area corresponding to an area where the screen flicker is likely to occur, the processing load on the host control unit 30 can be reduced. Furthermore, the host control unit 30 can also reduce the storage capacity for the histogram.

Furthermore, in a case where the image judgment unit 34 determines that flicker is prone to occur in the image analysis area 13, the drive change unit 36 may determine that a high refresh rate (for example, 60 Hz) is used for only a part of the area 14 of the screen 11a or 11b in driving. In the active-matrix display apparatus, writing to pixels is performed on a scanning line-by-scanning line bases, and thus the display apparatus is allowed to update displaying only in the area 14 including a plurality of scan signal lines corresponding to the analysis area 13. The drive change unit 36 may determine that areas other than the area 14 are to be driven at a low refresh rate (for example, 1 Hz). According to the driving method described above, the host control unit 30 can effectively achieve both low power consumption of the display apparatus 1 and a reduction in flicker visibility.

Note that in the case where a part of the area of the image is employed as the predetermined area, the method of setting the predetermined area by the image judgment unit 34 is not limited to the method described above. For example, in a case where a part of the image included in the display data acquired by the image judgment unit 34 includes an area where gradation levels within the gradation range are concentrated, the area where the gradation levels are concentrated may be employed as the predetermined area.

### Second Embodiment

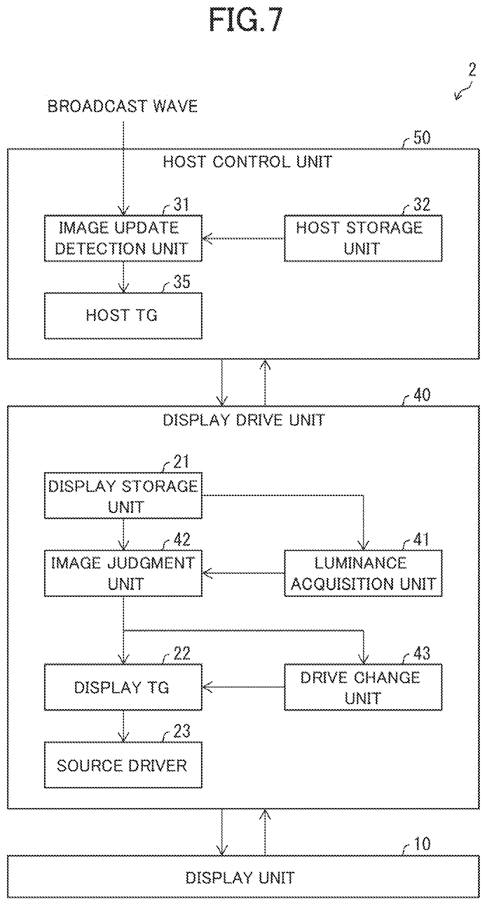

A second embodiment of the present disclosure is described below with reference to FIG. 7. For convenience of explanation, constitutional elements having the same functions as those of constitutional elements according to the previous embodiment are denoted by the same reference numerals, and a duplicated description thereof is not given.

A display apparatus 2 according to the second embodiment is different from the display apparatus 1 according to the first embodiment in that an image judgment unit 42, a luminance acquisition unit 41, and a drive change unit 43 for determining the refresh rate are provided in a display drive unit 40, which is realized by a COG driver, a COF driver, a COP driver, or the like.

### Configuration of Display Apparatus 2

As shown in FIG. 7, the display apparatus 2 includes a display unit 10, a display drive unit 40, and a host control unit (a control apparatus) 50.

The display drive unit 40 drives the display unit 10. The display drive unit 40 may be, for example, a so-called COG driver which is COG-mounted on a glass substrate of the display unit 10, or a so-called COF driver which is COF-mounted on a flexible substrate of the display unit 10. Alternatively, the display drive unit 20 may be a so-called COP (Chip on Plastic) driver which is COP-mounted on a plastic substrate of the display unit 10. The host control unit 50 is a control board including a control circuit formed on the board, and is mainly responsible for a control of the display apparatus 2 other than the control relating to displaying. In the display apparatus 2 according to the present embodiment, the display drive unit 40 determines the refresh rate. This results in a reduction in the processing load on the host control unit 50, which ensures that the host control unit 50 has a processing capacity for performing processing other processing related to the displaying.

### Configuration of Host Control Unit 50

The host control unit 50 includes a screen update detection unit 31, a host storage unit 32, and a host TG 35. The functions of the respective units included in the host control unit 50 are as described in the first embodiment. The host control unit 50 transfers the display data of an image to be updated to the display drive unit 40 only when the display is to be updated.

The display drive unit 40 includes a display storage unit 21, a display TG 22, a source driver 23, a luminance acquisition unit 41, an image judgment unit 42, and a drive change unit 43.

The luminance acquisition unit 41 acquires the luminance of the screen of the display unit 10 and outputs it to the image judgment unit 42.

When the display driving unit 40 acquires display data from the host control unit 50, the image judgment unit 42 acquires display data from the display storage unit 21. Furthermore, the image judgment unit 42 acquires a luminance value from the luminance acquisition unit 41. The image judgment unit 42 makes a determination, based on a gradation level of an image included in the display data and the luminance value, as to whether or not the image is an image which is prone to flicker. The determination process by the image determination unit 42 is as described in the first embodiment. The image judgment unit 42 outputs the display data to the display TG 22 and outputs the determination result to the drive change unit 43.

The drive change unit 43 determines the refresh rate based on the determination result supplied from the image judgment unit 42, and outputs the determined refresh rate to the display TG 22 such that the display unit 10 is driven at the determined refresh rate.

The display TG 22 transfers the display data acquired from the image judgment unit 42 to the source driver 23 according to the refresh rate determined by the drive change unit 43. The configuration of the source driver 23 is the same as that according to the first embodiment.

### Third Embodiment

A third embodiment of the present disclosure is described below with reference to FIG. 1. A display apparatus 3 according to the third embodiment is different from the display apparatus 1 according to the first embodiment in that a host control unit 30 further includes a bias determination unit (a determination unit) 37.

In the display apparatus 3, when an image judgment unit 34 determines that an image is prone to flicker, the drive change unit 36 determines that displaying is to be performed at a high refresh rate. In a case where displaying is performed at a low refresh rate, the display unit 10 has a mixture of an update frame and a pause frame wherein refreshing of displaying and light emission by an EL element are both performed in the update frame, while in the pause frame, light emission by an EL element is performed although refreshing of displaying is not performed. In the display apparatus 3 including EL elements which are self-luminous elements, the EL elements perform light emission in both the update frame and the pause frame as described above in order to continue displaying in the display unit 10.

In EL elements, it is known that a change in the emission luminance of EL elements occurs between an update frame and a pause frame, and this change causes flicker. Studies performed by the inventors have shown that the change described above is caused by an occurrence of a shift between an update frame and a pause frame in terms of a characteristic of a transistor that is disposed in each EL element to control a light emission current of the EL element. The shift of the characteristic occurs because there may be a difference in the magnitude of the voltage applied to the above-described transistor between the update frame and the pause frame.

In the display apparatus 3 according to the present embodiment, in order to reduce the shift of the characteristic, a bias voltage (a voltage which is applied during driving in which data is not rewritten) is applied to the above-described transistor such that the voltage applied to the transistor during the pause frame is substantially the same as the voltage applied during the update frame. It may be desirable that the bias voltage is applied to the above-described transistor during a light-off period during which is the EL element does not emit light in the pause frame.

The length of the light-off period of the EL element in the pause frame varies depending on the emission duty of the EL element, the number of emission pulses, and/or the like. Therefore, in the display apparatus 3, by applying a bias voltage having a magnitude corresponding to the length of the light-off period to the above-described transistor, it is possible to apply the voltage with substantially the same magnitude to the above-described transistor regardless of the characteristic of the EL element and the display setting of the display unit 10. Thus, it becomes easy to apply the voltage with substantially the same magnitude to the above-described transistor without having a change between the update frame and the pause frame.

The host control unit 30 includes the bias determination unit 37. When the image judgment unit 34 determines that the image of interest is an image which is prone to flicker, that is, when the drive change unit 36 determines that displaying is to be performed at a high refresh rate, the bias determination unit 37 determines the magnitude of the bias voltage to be applied to the above-described transistor or determines the period during which the bias voltage is to be applied. The bias determination unit 37 determines the magnitude of the bias voltage according to the length of the light-off period of the EL element in the pause frame. In other words, in a case where the drive change unit 36 determines that a first rate is to be used as the refresh rate, the bias determination unit 37 determines the magnitude of the bias voltage according to the length of the light-off period during which the EL element does not emit light in the pause frame.

More specifically, the bias determination unit 37 may determine the magnitude of the bias voltage such that shorter the light-off period in the pause frame, the larger the magnitude of the bias voltage. For example, when the light-off period of the EL element in the pause frame is shorter than a predetermined threshold value, the bias determination unit 37 may determine that a first voltage is to be employed as the bias voltage. When the light-off period of the EL element in the pause frame is equal to or larger than the predetermined threshold value, the bias determination unit 37 may determine that a second voltage larger than the first voltage is to be employed as the bias voltage

By employing the above-described configuration, it becomes possible for the host control unit 30 to change the bias voltage when it is determined, from the gradation level of the image and the luminance value of the screen of the display unit 10, that the image is an image prone to flicker. Thus, the host control unit 30 can apply an optimum bias voltage to the above-described transistor according to the content of the image such that flicker is less likely to occur.

Note that in the display apparatus 2 according to the second embodiment, no bias determination unit is shown in FIG. 7. However, the display drive unit 40 of the display apparatus 2 may include a bias determination unit, and this bias determination unit may perform the above-described processing.

### Modifications

The process of determining the magnitude of the bias voltage by the bias determination unit 37 is not limited to the example described above, but various modifications are possible.

The bias determination unit 37 may determine the magnitude of the bias voltage depending on the characteristic of the display unit 10 (the characteristic of individual display unit 10). The characteristic of the display unit 10 may be that indicating how much the possibility of occurrence of the shift of the characteristic of the transistor increases as the refresh rate decreases. For example, depending on the characteristics of the display unit 10, there is a possibility that the characteristic shift of the transistor by substantially the same bias voltage up to the lowest settable refresh rate (for example, 0.0056 Hz). In this case, the bias determination unit 37 may determine the bias voltage such that the bias voltage have the largest margin for the lowest refresh rate.

On the other hand, depending on the characteristic of the display unit 10, it may be difficult to suppress the shift of the characteristic of the transistor with substantially the same bias voltage when the refresh rate is low. In this case, the bias determination unit 37 may change the bias voltage to a more appropriate value after an elapse of a predetermined period of time in which a series of pause frames has occurred.

The bias determination unit 37 may determine the magnitude of the bias voltage depending on the temperature of the display unit 10. That is, the display unit 10 may include a temperature sensor for detecting the temperature of the display unit 10, and the bias determination unit 37 may acquire the temperature of the display unit 10 from the temperature sensor. The higher the temperature of the display unit 10, the more likely the shift of the characteristic of the transistor is to occur, and thus the more strictly, the bias voltage is to be controlled.

Depending on the refresh rate value and the characteristic of the display unit 10, it may be difficult to sufficiently suppress the occurrence of flicker only by controlling the bias voltage by the bias determining unit 37. This situation may occur, for example, when the voltage determined by the bias determining unit 37 is larger than the upper limit of the voltage that can be applied to the transistor. In this case, the drive change unit 36 may set a lower limit value of the refresh rate and may determine the refresh rate such that it is larger than the lower limit value. In other words, when the bias voltage determined by the bias determination unit 37 is larger than the largest voltage that can be applied to the EL element, the lower limit of the employable refresh rate may be set to a value higher than the first rate. Instead of the drive change unit 36, the bias determination unit 37 may determine the refresh rate.

As described in the first embodiment, the visibility of the flicker varies depending on the luminance value of the screen of the display unit 10. Therefore, the bias determination unit 37 may determine the magnitude of the bias voltage according to the luminance value acquired by the luminance acquisition unit 33. The smaller the luminance value of the screen of the display unit 10, the higher the visibility of the flicker. Therefore, for example, the bias determination unit 37 may perform the determination of the bias voltage when the luminance value is smaller than a predetermined threshold value (which may be equal to or may be different from the luminance threshold value described above. In this case, the drive change unit 36 may set the lower limit value of the refresh rate depending on the above-described luminance value.

### Examples of Implementations by Software

Control blocks (in particular, the image judgment unit 34 and the drive change unit 36) of the host control unit 30 may be realized by a logic circuit (hardware) formed in an integrated circuit (an IC chip) or the like, or may be realized by software.

In the latter case, the host control unit 30 includes a computer that executes instructions of a program that is software for realizing functions. The computer includes, for example, at least one processor (a control apparatus) and at least one computer-readable storage medium in which the program is stored. In the computer, the processor reads the program from the storage medium and executes the program thereby achieving an aspect of the present disclosure. For example, a CPU (Central Processing Unit) may be used as the processor. The storage medium may be a “non-transitory tangible medium”, such as a read-only memory (ROM), a tape, a disk, a card, a semiconductor memory, a programmable logic circuit, or the like. A RAM (Random Access Memory) or the like for loading the program may also be provided. Alternatively, the program may be supplied to the computer via a transmission medium (a communication network, a broadcast wave, or the like) capable of transmitting the program. Note that an aspect of the present disclosure may also be realized in the form of a data signal embedded in a carrier wave such that the program is embodied by electronic transmission.

### Summary of Embodiments

According to a first aspect of the present disclosure, there is provided a control apparatus configured to control a display apparatus including a self-luminous element, the control apparatus including an image judgment unit configured to determine whether or not a ratio of a number of pixels located in a predetermined area of an image and having gradation levels within a gradation range from a first gradation level not equal to a lowest gradation level to a second gradation level not equal to a highest gradation level is equal to or larger than a threshold value, and a drive change unit configured to determine a refresh rate of the display apparatus including the self-luminous element according to a result of the determination made by the image judgment unit, the image judgment unit being configured to determine at least one of (1) the value of the first gradation level and the value of the second gradation level, and (2) the threshold value.

The control apparatus according to a second aspect, based on the first aspect, may further include a luminance value acquisition unit configured to acquire a set value for the luminance, wherein at least one of (1) the value of the first gradation level and the value of the second gradation level, and (2) the threshold value, may be set depending on the set value for the luminance.

In the control apparatus according to a third aspect, based on the second aspect, the image judgment unit may determine the threshold value such that in a case where the set value for the luminance is smaller than a predetermined luminance threshold value, the threshold value is set to a first threshold value, while in a case where the set value for the luminance is equal to or larger than the predetermined luminance threshold value, the threshold value is set to a second threshold value larger than the first threshold value.

In the control apparatus according to a fourth aspect, based on the second or third aspect, the image judgment unit may set the first and second gradation levels such that in a case where the set value for the luminance is smaller than a predetermined luminance threshold value, the first gradation level is set to a first set value and the second gradation level is set to a second set value, while in a case where the set value for the luminance is equal to or larger than the predetermined luminance threshold value, the first gradation level is set to a third set value smaller than the first set value and the second gradation level is set to a fourth set value smaller than the second set value, a range from the first set value to the second set value being larger than a range from the third set value to the fourth set value.

In the control apparatus according to a fifth aspect, based on one of the second to fourth aspects, the luminance acquisition unit may acquire the set value for the luminance by calculating the set value for the luminance from a voltage applied to the display apparatus including the self-luminous element.

In the control apparatus according to a sixth aspect, based on one of the second to fourth aspects, the luminance acquisition unit may be connected to a storage unit storing setting information associated with the display apparatus including the self-luminous element, and the luminance acquisition unit may acquire the set value for the luminance included in the setting information from the storage unit.

In the control apparatus according to a seventh aspect, based on one of the second to sixth aspects, the drive change unit may determine the refresh rate such that in a case where a ratio of a number of pixels having gradation levels within the gradation range is smaller than the threshold value, a first rate is determined as the refresh rate, while in a case where the ratio of the number of pixels having gradation levels within the gradation range is equal to or larger than the threshold value, a second rate higher than the first rate is determined as the refresh rate.

In the control apparatus according to an eighth aspect, based on one of the second to seventh aspects, driving without rewriting data may be performed once in a pause frame.

The control apparatus according to a ninth aspect, based on one of the second to eighth aspects, may further include a determination unit configured to determine a magnitude of a voltage used in driving without rewriting data, or determine a period during which the voltage is applied.

In the control apparatus according to a tenth aspect, based on the ninth aspect, the determination unit may determine the magnitude of the voltage, the period for applying the voltage, or the refresh rate according to a characteristic of the individual display apparatus including the self-luminous element.

In the control apparatus according to an eleventh aspect, based on the ninth or tenth aspect, the determination unit may determine the magnitude of the voltage, the period for applying the voltage, or the refresh rate according to a temperature of a display unit of the display apparatus including the self-luminous element.

The control apparatus according to a twelfth aspect, based on one of the ninth to eleventh aspects, the determination unit may determine the magnitude of the voltage, the period for applying the voltage, or the refresh rate according to the set value for the luminance.

According to a thirteenth aspect of the present disclosure, there is provided a display apparatus including a self-luminous element, wherein the display apparatus includes the control apparatus according to one of the first to twelfth aspects.

According to a fourteenth aspect of the present disclosure, there is provided a control method including acquiring a set value for luminance of the display apparatus including the self-luminous element, determining whether or not a ratio of a number of pixels located in a predetermined area of an image and having gradation levels within a gradation range from a first gradation level not equal to a lowest gradation level to a second gradation level not equal to a highest gradation level is equal to or larger than a threshold value, and changing a refresh rate of the display apparatus including the self-luminous element according to a result of the determining, the determining including setting at least one of (1) the value of the first gradation level and the value of the second gradation level, and (2) the threshold value, according to the set value for the luminance.

The display control apparatus according to any one of aspects of the present disclosure may be realized by a computer. In this case, a control program that causes the computer to operate as various units (software elements) of the display control apparatus thereby realizing the display control apparatus on the computer, and a computer-readable storage medium in which the control program is stored also fall within the scope of an aspect of the present disclosure.

Note that the present disclosure is not limited to the embodiments described above, and various modifications are possible within the scope described in claims. Embodiments obtained by combining the technical means disclosed in embodiments also fall within the technical scope of the present disclosure. A new technical feature may be achieved by combining technical means disclosed in the embodiments.

It should be understood by those skilled in the art that various modifications, combinations, sub-combinations and alterations may occur depending on design requirements and other factors insofar as they are within the scope of the appended claims or the equivalents thereof.

What is claimed is:

1. A control apparatus configured to control a display apparatus including a self-luminous element, comprising:
an image judgment unit configured to determine whether or not a ratio of a number of pixels located in a predetermined area of an image and having gradation levels within a gradation range from a first gradation level not equal to a lowest gradation level to a second gradation level not equal to a highest gradation level is equal to or larger than a threshold value; and
a drive change unit configured to determine a refresh rate of the display apparatus including the self-luminous element according to a result of the determination made by the image judgment unit,
the image judgment unit being configured to determine at least one of (1) the value of the first gradation level and the value of the second gradation level, and (2) the threshold value.

2. The control apparatus according to claim 1, further comprising a luminance value acquisition unit configured to acquire a set value for the luminance, wherein at least one of (1) the value of the first gradation level and the value of the second gradation level, and (2) the threshold value, may be set depending on the set value for the luminance

3. The control apparatus according to claim 2, wherein the image judgment unit determines the threshold value such that in a case where the set value for the luminance is smaller than a predetermined luminance threshold value, the threshold value is set to a first threshold value, while in a case where the set value for the luminance is equal to or larger than the predetermined luminance threshold value, the threshold value is set to a second threshold value larger than the first threshold value.

4. The control apparatus according to claim 2, wherein
the image judgment unit sets the first and second gradation levels such that in a case where the set value for the luminance is smaller than a predetermined luminance threshold value, the first gradation level is set to a first set value and the second gradation level is set to a second set value, while in a case where the set value for the luminance is equal to or larger than the predetermined luminance threshold value, the first gradation level is set to a third set value smaller than the first set value and the second gradation level is set to a fourth set value smaller than the second set value,
a range from the first set value to the second set value being larger than a range from the third set value to the fourth set value.

5. The control apparatus according to claim 2, wherein the luminance acquisition unit acquires the set value for the luminance by calculating the set value for the luminance from a voltage applied to the display apparatus including the self-luminous element.

6. The control apparatus according to claim 2, wherein
the luminance acquisition unit is connected to a storage unit storing setting information associated with the display apparatus including the self-luminous element, and
the luminance acquisition unit acquires the set value for the luminance included in the setting information from the storage unit.

7. The control apparatus according to claim 2, wherein the drive change unit determines the refresh rate such that in a case where a ratio of a number of pixels having gradation levels within the gradation range is smaller than the threshold value, a first rate is determined as the refresh rate, while in a case where the ratio of the number of pixels having gradation levels within the gradation range is equal to or larger than the threshold value, a second rate higher than the first rate is determined as the refresh rate.

8. The control apparatus according to claim 2, wherein driving without rewriting data is performed once in a pause frame.

9. The control apparatus according to claim 2, further comprising a determination unit configured to determine a magnitude of a voltage used in driving without rewriting data, or determine a period during which the voltage is applied.

10. The control apparatus according to claim 9, wherein the determination unit determines the magnitude of the voltage, the period for applying the voltage, or the refresh rate according to a characteristic of the individual display apparatus including the self-luminous element.

11. The control apparatus according to claim 9, wherein the determination unit determines the magnitude of the voltage, the period for applying the voltage, or the refresh rate according to a temperature of a display unit of the display apparatus including the self-luminous element.

12. The control apparatus according to claim 9, wherein the determination unit determines the magnitude of the voltage, the period for applying the voltage, or the refresh rate according to the set value for the luminance.

13. A display apparatus including a self-luminous element, wherein the display apparatus comprises the control apparatus according to claim 1.

14. A method of controlling a display apparatus including a self-luminous element, comprising:
acquiring a set value for luminance of the display apparatus including the self-luminous element;
determining whether or not a ratio of a number of pixels located in a predetermined area of an image and having gradation levels within a gradation range from a first gradation level not equal to a lowest gradation level to a second gradation level not equal to a highest gradation level is equal to or larger than a threshold value; and
changing a refresh rate of the display apparatus including the self-luminous element according to a result of the determining,
the determining including setting at least one of (1) the value of the first gradation level and the value of the second gradation level, and (2) the threshold value, according to the set value for the luminance.
